(19) United States
(12) Patent Application Publication
(10) Pub. No.: US 2012/0037469 A1
(43) Pub. Date: Feb. 16, 2012

(54) Air pressure buffer stick

(76) Inventor: Teng-Yi JUAN, Taipei City (TW)

(21) Appl. No.: 12/854,104

(22) Filed: Aug. 10, 2010

(51) Int. Cl. F16F 11/00

(52) U.S. Cl. 188/271

(57) ABSTRACT

An air pressure buffer stick comprises a pressure cylinder, a piston including an air through hole, and a moving rod having a first end connected to the piston. The first end of the moving rod is disposed in the pressure cylinder. A second end of the moving rod extends out of an open end of the pressure cylinder, and an end of the pressure cylinder opposite the open end is closed. The moving rod connected with the piston is allowed to move to and fro in the pressure cylinder. By such arrangements, the friction between the piston and the inner surface of the pressure cylinder and the counterforce of the air flowing therethrough both provide the buffer force of the air pressure buffer stick, thus reducing the wear rate of the piston while extending the service life of the air pressure buffer stick.

### BACKGROUND OF THE INVENTION

1. Field of the Invention

The present invention relates to a buffer mechanism, and more particularly to an air pressure buffer stick.

2. Description of the Prior Art

Referring to FIG. 1, a first conventional air pressure buffer stick 10 comprises a pressure cylinder 11, a piston lever 12, and a seal cover 13. The pressure cylinder 11 is formed with a through hole 111 in a first end thereof, and a second end of the pressure cylinder 11 is formed with an opening 112. The piston lever 12 includes a piston 121 connected to a lever portion 122 and is disposed in the pressure cylinder 11 through the opening 112 of the pressure cylinder 11, and then the seal cover 13 seals the opening 112. The lever portion 122 of the piston lever 12 is connected to other mechanisms. By such arrangements, a friction will be produced between the piston 121 of the piston lever 12 and the inner surface of the pressure cylinder 11 when the piston lever 12 extends out of the pressure cylinder 11, which will slow down the moving speed of the lever portion 122 relative to the pressure cylinder 11, offering a buffer effect. When the piston lever 12 retracts into the pressure cylinder 11, the air in the pressure cylinder 11 will be discharged through the through hole 111, similarly, a friction will be produced between the piston 121 of the piston lever 12 and the inner surface of the pressure cylinder 11 to slow down the moving speed of the piston lever 12 relative to the pressure cylinder 11, offering the buffer effect.

Referring to FIG. 2, a second conventional air pressure stick 20 comprises a pressure cylinder 21, a piston lever 22 and a seal cover 23. The pressure cylinder 21 is formed in an inner surface thereof with plural air guide channels 211. The pressure cylinder 21 includes an opening 212. The piston lever 22 includes a piston 221 connected to a lever portion 222 and is disposed in the pressure cylinder 21 through the opening 212, and the seal cover 23 seals the opening 212. By such arrangements, when the piston lever 22 is moved, a friction will be produced between the piston 221 of the piston lever 22 and the inner surface of the pressure cylinder 21 to slow down the moving speed of the piston lever 22 relative to the pressure cylinder 22, offering the buffer function, meanwhile, the air guide channels 211 can guide the air into the pressure cylinder 21 to prevent the pressure cylinder 21 from failing due to vacuum effect.

As known from the abovementioned, the conventional air pressure sticks 10, both offer the buffer effect through the friction produced between the inner surface of the pressure cylinder and the piston of the piston lever, but they cannot effectively keep the air in the air pressure sticks to produce the air pressure buffer effect. In addition, such an operating manner might cause the piston of the piston lever to wear out quickly, which greatly weakening the buffer effect of the air pressure stick, as result of this, the user needs to replace the piston lever frequently, leading to the increase of the cost.

The present invention has arisen to mitigate and/or obviate the afore-described disadvantages.

### SUMMARY OF THE INVENTION

The primary objective of the present invention is to provide an air pressure buffer stick whose buffering force is provided by the friction of the piston and the counterforce of the air, reducing the wear rate of the piston while extending the service life of the air pressure buffer stick.

To achieve the above objective, an air pressure buffer stick in accordance with the present invention comprises a pressure cylinder, a piston and a moving rod.

The pressure cylinder is a pipe and formed with an open end.

The piston is in the form of a cylinder defined in an outer periphery thereof with an annular groove and deformable. The piston is formed with an air through hole and disposed in the moving space of the pressure cylinder.

The moving rod includes a piston connecting element and a rod element at both ends thereof. The piston connecting element includes an inserting portion and an abutting portion at both ends thereof. The inserting portion of the moving rod is inserted into the air through hole of the piston, and the abutting portion abuts outside the piston. The abutting portion is formed with at least one first ventilated unit, and the inserting portion is formed with at least one second ventilated unit. The rod element of the moving rod extends out of the open end of the pressure cylinder.

The pressure cylinder has an end opposite the open end thereof closed, and the piston is formed with the air through hole, so that when the moving rod together with the piston moves, the counterforce of the air will make the piston deform. The friction produced between the piston and the pressure cylinder and the counterforce of the air flowing therethrough both provide the buffering force of the air pressure buffer stick, reducing the wear rate of the piston while extending the service life of the air pressure buffer stick.

### BRIEF DESCRIPTION OF THE DRAWINGS

FIG. 1 is an assembly view of a first conventional air pressure buffer stick;

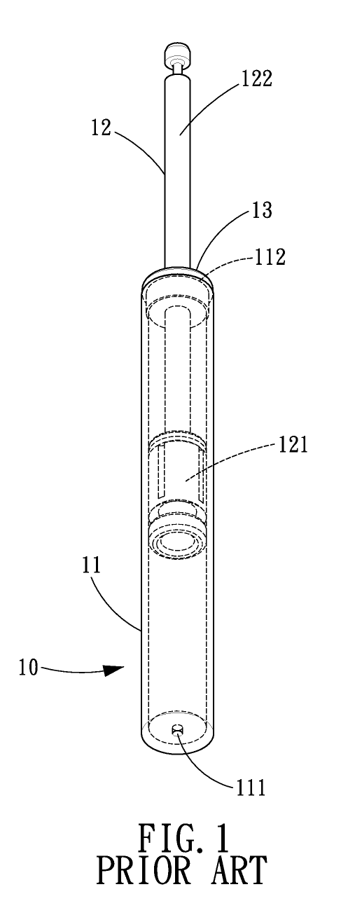

FIG. 2 is a cross-sectional view of a second conventional air pressure buffer stick;

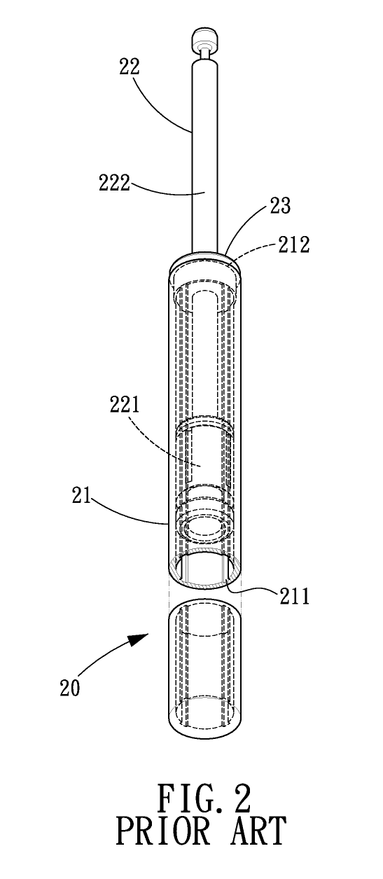

FIG. 3 is an exploded view of an air pressure buffer stick in accordance with a first embodiment of the present invention;

FIG. 4 is a cross-sectional view of the air pressure buffer stick in accordance with the first embodiment of the present invention;

FIG. 5 is an operational cross-sectional view of the air pressure buffer stick in accordance with the first embodiment of the present invention;

FIG. 6 is a cross-sectional view showing a flow path of the air when the air is subjected to a relatively smaller pressure to make the moving rod and the piston be fitted in a loose manner;

FIG. 7 is a cross-sectional view showing a flow path of the air when the air is subjected to a relatively greater pressure to make the moving rod and the piston be closely fitted; and

FIG. 8 is a cross-sectional view of an air pressure buffer stick in accordance with a second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

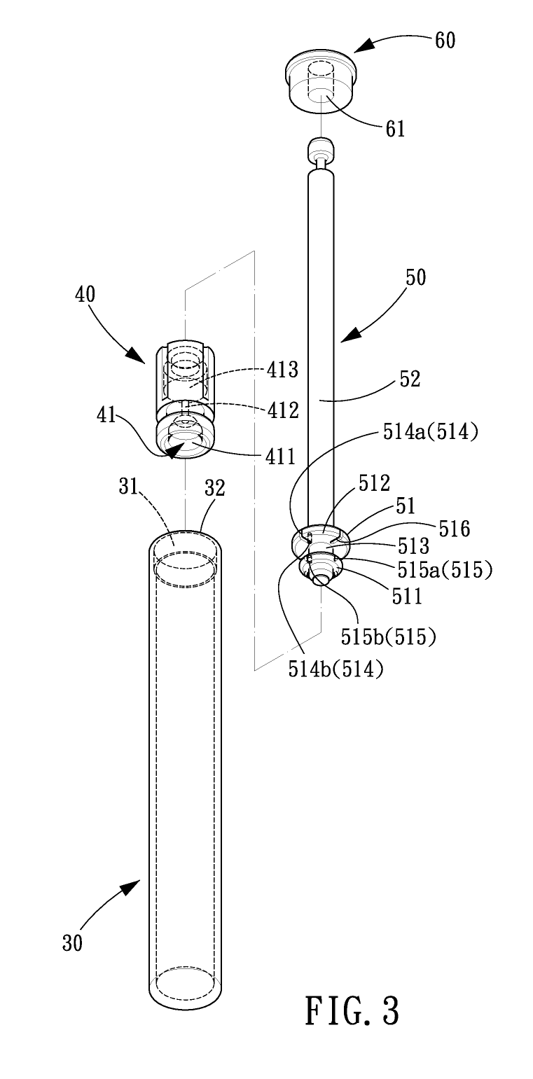

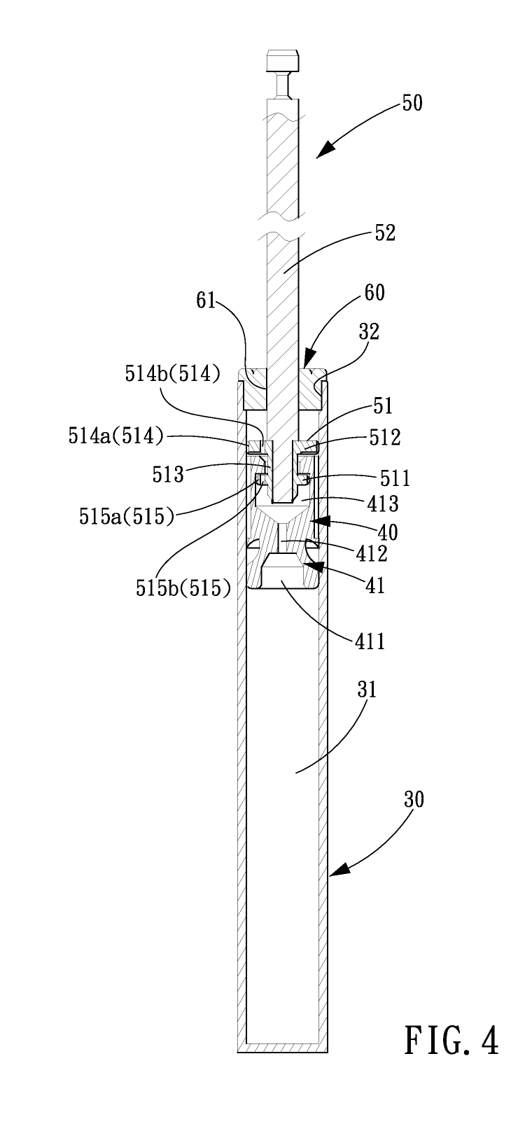

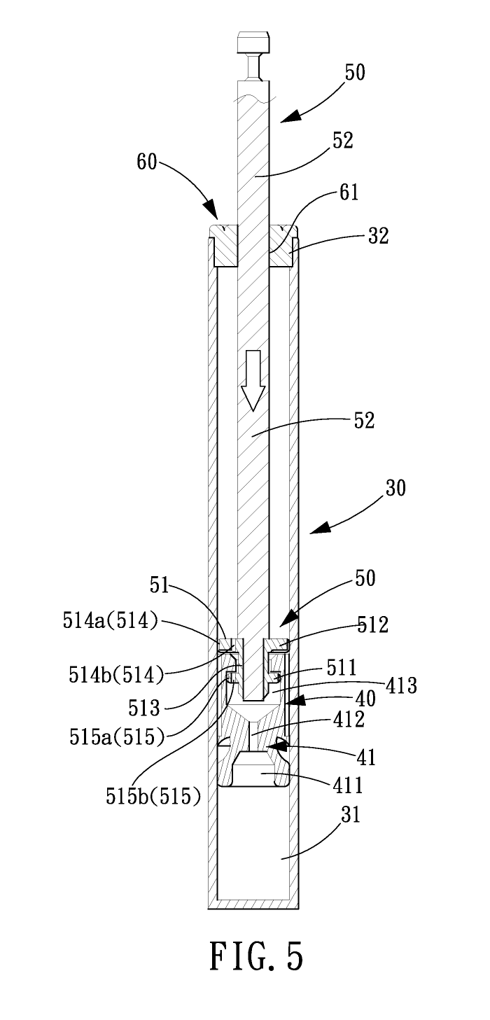

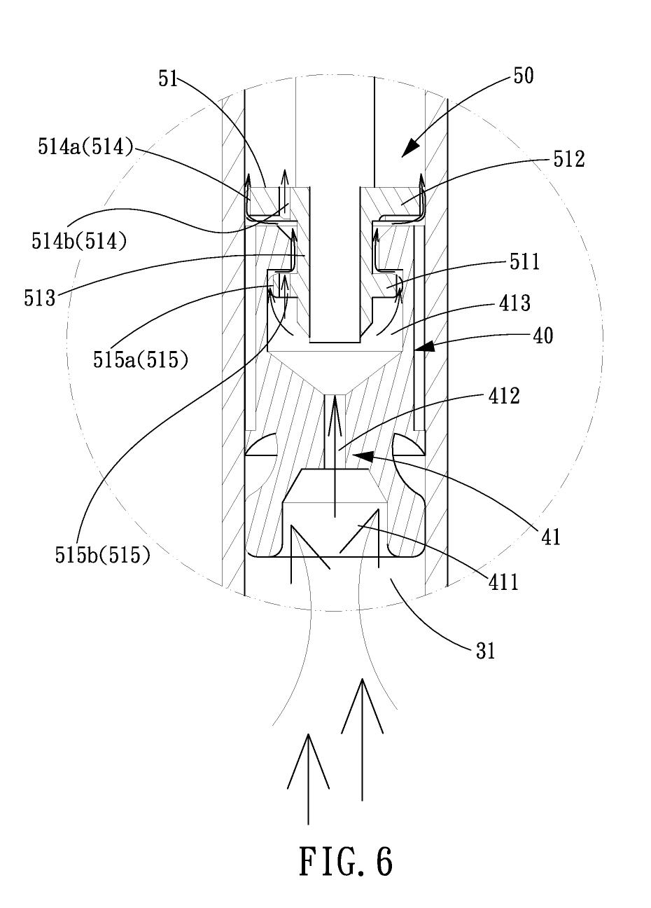

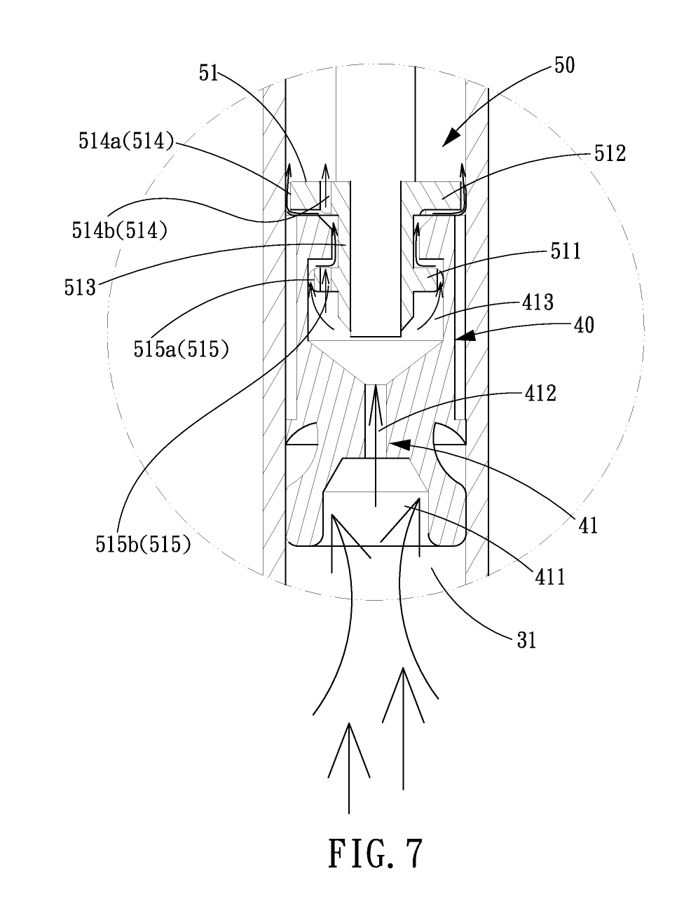

Referring to FIGS. 3-7, an air pressure buffer stick in accordance with a first embodiment of the present invention comprises a pressure cylinder 30, a piston 40, a moving rod 50 and a seal cover 60.

The pressure cylinder 30 is a pipe and includes a moving space 31 and an open end 32.

The piston 40 is in the form of a cylinder defined in an outer periphery thereof with an annular groove and formed with an air through hole 41. The piston 40 is deformable and made of a material selected from the group consisting of rubber, polyurethane and silica gel. In the present embodiment, the piston 40 is made of rubber. The air through hole 41 of the piston 40, in order, includes a first expansion segment 411, a second expansion segment 412 and a third expansion segment 413. The first expansion segment 411 and the third expansion segment 413 are both tapered toward the second expansion segment 412, and a diameter of the second expansion segment 412 is smaller than that of both the first expansion segment 411 and the third expansion segment 413. The piston 40 is disposed in the moving space 31 of the pressure cylinder 30.

The moving rod 50 includes a piston connecting element 51 and a rod element 52 at both ends thereof. The piston connecting element 51 includes an inserting portion 511 and an abutting portion 512 at both ends thereof. An outer diameter of the inserting portion 511 is sized correspondingly to an inner diameter of the piston 40, and an outer diameter of the abutting portion 512 is greater than that of the inserting portion 511. Between the inserting portion 511 and the abutting portion 512 is connected a concave middle portion 513. An outer diameter of the middle portion 513 is smaller than the inner diameter of the piston 40. The inserting portion 511 of the moving rod 50 is inserted into the air through hole 41 through the third expansion segment 413 of the piston 40, and the abutting portion 512 abuts outside the piston 40. The abutting portion 512 is formed with at least one first ventilated unit 514, and the first ventilated unit 514 is formed with plural spaced notches 514a in a circumference of the abutting portion 512, or formed with a through hole 514b in the abutting portion 512. In addition, the first ventilated unit 514 can also be formed with both the plural spaced notches 514a and the through hole 514b at the same time. The inserting portion 511 is formed with at least one second ventilated unit 515, and the second ventilated unit 515 of the inserting portion 511 is formed with plural spaced notches 515a in a circumference of the inserting portion 511, or formed with a through hole 515b in the inserting portion 511. In addition, the second ventilated unit 515 can also be formed with both the spaced notches 515a and the through hole 515b in the inserting portion 511 at the same time. The abutting portion 512 is formed in a surface thereof facing the inserting portion 511 with a circulation channel 516 which is in communication with the notch-formed first ventilated unit 514. The moving rod 50 is connected to the piston 40 and disposed in the pressure cylinder 30 with the rod element 52 of the moving rod 50 extending out of the open end 32 of the pressure cylinder 30.

The seal cover 60 is centrally formed with a through hole 61 through which the seal cover 60 is engaged on the rod element 52 of the moving rod 50 to seal the open end 32 of the pressure cylinder 30.

The aforementioned is the summary of the positional and structural relationship of the respective components of the preferred embodiment in accordance with the present invention. After the moving rod 50 and the piston 40 are combined, the moving rod 50 can linearly move within the pressure cylinder 30 together with the piston 40. When the moving rod 50 together with the piston 40 moves outwards relative to the pressure cylinder 30, a friction will be produced between the piston 40 and an inner surface of the pressure cylinder 30, and the air will be drawn into the pressure cylinder 30, offering the buffer effect. When the moving rod 50 together with the piston 40 moves inwards relative to the pressure cylinder 30, since the pressure cylinder 30 is filled with the air, the piston 40 will compress the air, and then the air will enter the piston 40 only through the air though hole 41. Since the moving rod 50 includes the concave middle portion 513, when the moving rod 50 is inserted in the piston 40, between the middle portion 513 of the moving rod 50 and the inner surface of the piston 40 is defined a clearance, which allows the moving rod 50 to rotate freely in the piston, presenting a loose-fit state. As a result, if the piston 40 is pushed by a relatively smaller force, that is, if the piston 40 applies a relatively smaller pressure to the air, the air will flow out through the air through hole 41 of the piston 40 and the clearance between the piston 40 and the piston connecting element 51, so that the friction between the piston 40 and the inner surface of the pressure cylinder 30, and the counterforce of the air flowing therethrough can both offer the buffer effect.

If the piston 40 is pushed into the pressure cylinder 30 by a relatively greater pressure, that is, if the piston 40 applies a relatively greater pressure on the air, the counterforce of the air is relatively greater. Since the piston 40 includes the air through hole 41, while pushing the air into the pressure cylinder 30 through the air through hole 41 of the piston 40, the counterforce of the air will make the first expansion segment 411 of the air through hole 41 of the piston 40 expand, at this moment, the friction between the piston 40 and the pressure cylinder 30 will provide a first buffering force. When continuing flowing through the air through hole 41, the air will flow from the first expansion segment 411 into the third expansion segment 413 through the second expansion segment 412. Since the diameter of the second expansion segment 412 is smaller than that of both the first and the third expansion segments 411, 413, the air will be compressed and then flow into the third expansion segment 413. After that, when the air enters the third expansion segment 413, the third expansion segment 413 will be made to expand, so that the piston 40 will provide a second buffering force, that is, between the deformed piston 40 and the inner surface of the pressure cylinder 30 is produced a friction again, and the air which hasn't entered the piston 40 will again apply a counterforce onto the piston 40. Subsequently, the air will flow from the third expansion segment 413 into the clearance between the middle portion 513 of the piston connecting element 51 and the piston 40 through the second ventilated unit 515 of the inserting portion 511 of the piston connecting element 51, and then the air will continue to flow toward the abutting portion 512 and finally flow out of the pressure cylinder 30 through the circulation channel 516 and the first ventilated unit 514. To summarize, the air pressure buffer stick in accordance with the present invention can utilize both the friction produced between the piston 40 and the inner surface of the pressure cylinder 30 and the counterforce of the air to offer the buffering force, that is, the counterforce of the air and the friction together provide the buffering force of the air pressure buffer stick in accordance with the present invention, so that the wear rate of the piston 40 can be reduced, and the buffer effect of the air pressure buffer stick can be improved, furthermore, the replacement rate of the parts is correspondingly reduced, effectively reducing the cost while extending the service life of the air pressure buffer stick.

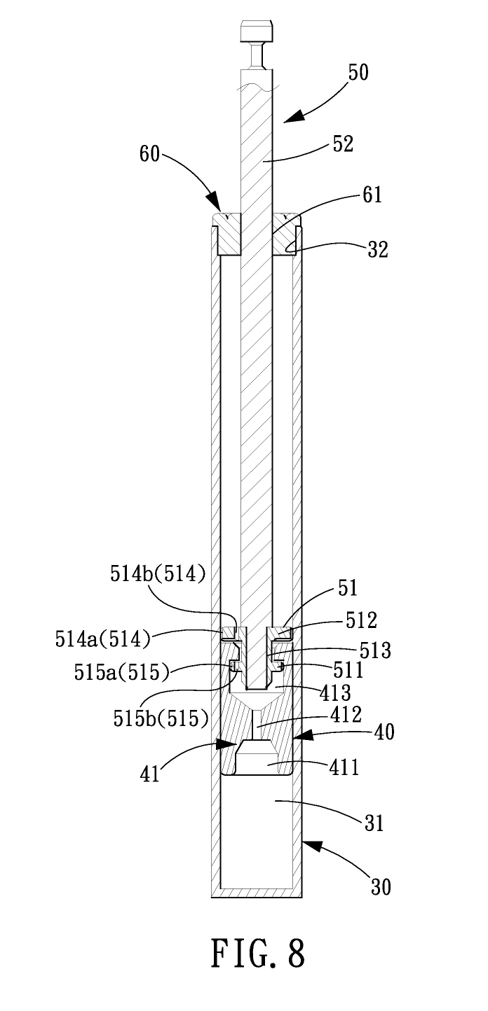

Please refer to FIG. 8 which illustrates an air pressure buffer stick in accordance with a second embodiment of the present invention, the piston 40 is in the form of a straight pipe and still includes the air through hole 41, so that the present embodiment of the present invention can offer the same function as the previous embodiment.

While we have shown and described various embodiments in accordance with the present invention, it is clear to those skilled in the art that further embodiments may be made without departing from the scope of the present invention.

What is claimed is:

1. An air pressure buffer stick comprising:
a pressure cylinder being a pipe and including a moving space and an open end;
a piston being in the form of a cylinder defined in an outer periphery thereof with an annual groove, the piston being deformable and formed with an air through hole, the piston being disposed in the moving space of the pressure cylinder; and
a moving rod including a piston connecting element and a rod element at both ends thereof, the piston connecting element including an inserting portion and an abutting portion at both ends thereof, the inserting portion of the moving rod being inserted into the air through hole of the piston, and the abutting portion abutting outside the piston, the abutting portion being formed with at least one first ventilated unit, the inserting portion being formed with at least one second ventilated unit, the rod element of the moving rod extending out of the open end of the pressure cylinder.

2. The air pressure buffer stick as claimed in claim 1, wherein the piston is made of a material selected from the group consisting of rubber, polyurethane and silica gel.

3. The air pressure buffer stick as claimed in claim 1, wherein an outer diameter of the inserting portion of the moving rod is sized correspondingly to an inner diameter of the piston.

4. The air pressure buffer stick as claimed in claim 1, wherein an outer diameter of the abutting portion is greater than an outer diameter of the inserting portion.

5. The air pressure buffer stick as claimed in claim 1, wherein the inserting portion is connected to the abutting portion through a concave middle portion, and an outer diameter of the middle portion is smaller than an inner diameter of the piston.

6. The air pressure buffer stick as claimed in claim 1, wherein the first ventilated unit of the moving rod is formed with plural spaced notches in a circumference of the abutting portion, and the second ventilated unit of the moving rod is formed with plural spaced notches in a circumference of the inserting portion.

7. The air pressure buffer stick as claimed in claim 1, wherein the first ventilated unit of the moving rod is formed with a through hole in the abutting portion, and the second ventilated unit of the moving rod is formed with a through hole in the inserting portion.

8. The air pressure buffer stick as claimed in claim 1 further comprising a seal cover, the seal cover being centrally formed with a through hole through which the seal cover is engaged on the rod element of the moving rod to seal the open end of the pressure cylinder.

9. The air pressure buffer stick as claimed in claim 1, wherein the air through hole of the piston, in order, includes a first expansion segment, a second expansion segment and a third expansion segment, the first expansion segment and the third expansion segment are both tapered toward the second expansion segment, and a diameter of the second expansion segment is smaller than that of both the first expansion segment and the third expansion segment.

10. The air pressure buffer stick as claimed in claim 6, wherein the abutting portion of the moving rod is formed in a surface thereof facing the inserting portion with a circulation channel which is in communication with the notch-formed first ventilated unit.
